(19) United States
(12) Patent Application Publication
(10) Pub. No.: US 2025/0137831 A1
(43) Pub. Date: May 1, 2025

(54) METHOD AND DEVICE FOR RECOGNIZING THE RISE IN A WATER LEVEL

(71) Applicant: Robert Bosch GmbH, Stuttgart (DE)

(72) Inventors: Georg Schneider, Ludwigsburg (DE); Armin Dertinger, Oeschingen (DE); Frank Schou, Ditzingen (DE)

(21) Appl. No.: 18/921,564

(22) Filed: Oct. 21, 2024

(30) Foreign Application Priority Data
Oct. 25, 2023 (DE) 10 2023 210 510.1

(51) Int. Cl. G01F 23/80; B60R 16/033; G07C 5/02; H01M 50/574

(52) U.S. Cl. CPC G01F 23/804; B60R 16/033; G07C 5/02; H01M 50/574; H01M 2220/20

(57) ABSTRACT

A method and a device by means of which dynamic water level information with respect to a vehicle can be generated. A processing unit which analyses and uses this water level information for higher-level purposes, in particular for other road users, is also described.

### FIELD

The present invention relates to a method and a device for recognizing the rise in a water level.

### BACKGROUND INFORMATION

If a vehicle leaves the road and falls into an adjacent body of water, the vehicle occupants may be unable to open the doors in time before the water pressure makes opening impossible. In this case, it is important to make it possible for the occupants to escape the sinking vehicle, for example by opening the windows.

The same applies if a stationary or slowly moving vehicle on a road is flooded by rapidly rising bodies of water.

For example, U.S. Pat. No. 11,383,661 B2 describes a method and a device in which a sensor variable is used to recognize whether a vehicle has fallen into water. Based on this finding, a door or window is opened, for example.

### SUMMARY

The present invention provides a system which recognizes the water level in contact dynamically.

The present invention provides a method and a device by means of which dynamic water level information with respect to a vehicle can be generated, as well as a processing unit which analyses and uses this water level information for higher-level purposes, in particular for other road users.

According to an example embodiment of the present invention, for generating the water level information, water level values in contact with the vehicle are determined. For determining the water level values or, in general, the rise in water, at least one sensor variable of a first sensor, of which the value changes directly or indirectly due to a water level rising at the vehicle is evaluated. Furthermore, the driving state of the vehicle is detected by means of at least one further sensor variable of a second sensor. The first water level value or the sensor variable associated with this water level value is used in a first comparison to recognize a rise in water on at least part of the vehicle. Even a single water level value or the sensor variable exceeding a threshold value can indicate the rise since no water is normally to be expected around the vehicle. It is subsequently detected how long this rise in water occurs and how strong the further rise is. This can be done, for example, by detecting a further sensor variable of the first sensor in order to determine, by means of a second comparison, the change in the sensor variable of the first sensor, the second water level value, or the continued exceedance of a threshold value. If an exceedance of a threshold value by the further sensor variable of the first sensor or the second water level value is also determined in this second comparison, the time difference between the detection of the two sensor variables or the determination of the underlying first and second water level values is determined as a time span. If this water level value or the associated water level on the vehicle lasts for a predetermined time duration, a short-term event can be ruled out and impairment of the vehicle must instead be expected. The same applies, of course, if it is determined that a further rise has been recognized in a determined time span with the second water level value. Based on the finding that a specified water level is in contact with the vehicle at least for a predetermined time duration, water level information is subsequently generated on the basis of the vehicle state and can be used for further purposes. The water level information may consist of a single value or a data set containing further information. For example, in addition to a mere indication of a flood level on the vehicle, the data may also contain the rate of rise, the duration of the exceedance of the first threshold value, the geoposition of the vehicle in the form of a location variable, a movement variable of the vehicle, a camera image or camera video, in particular of the surrounding area, or information regarding the occupants of the vehicle or the function of vehicle components.

An advantage of the possible recognition of the dynamics of the rise in water on a vehicle by means of the method according to the present invention can be extremely important both for the user of the vehicle and for other road users in order both to avoid damage to vehicles and to ensure the safety of vehicle occupants. The water level information generated in this way can also be used to warn other road users and protect existing infrastructure.

According to an example embodiment of the present invention, for recognizing a water level on the vehicle, which may impair the operation or safety of the vehicle, the at least one sensor variable of the first sensor or the first water level value derived therefrom can be compared to a threshold value in the first comparison. If the sensor variable or the first water level value exceeds a first threshold value, it can be assumed that the water in contact potentially poses a risk to the vehicle as such, to individual components, to the operation in general, or to the safety of the vehicle occupants. In the subsequent second comparison, this first threshold value can also be used to demonstrate that the rise in water is of a predetermined duration. The predetermined duration depends on the vehicle, the driving state, or even on individual components of the vehicle in order to take into account the impairment of the vehicle and/or of its components when water is in contact. For example, the effect of the seal on the doors, the installation position of the battery, of the motor, or of the electrical lines can also be taken into account. Alternatively, it may also be provided that the second comparison uses a second threshold value, which is higher in order to detect a further rise in water on the vehicle.

In a further example embodiment of the present invention, it may be provided that the second comparison is carried out twice in order to obtain further findings. Thus, a comparison is carried out first with the first threshold value and, if this first threshold value is exceeded by the detected sensor variable, the derived second water level value, or a water level gradient, a further comparison with a higher second threshold value is carried out. This two-part second comparison provides not only the time span in which the first threshold is exceeded but also information regarding the further dynamics of the rise in water. This information can then be additionally included in the generation of the water level information or added to the data if the water level information is generated in the form of a data set. This specific and dynamic information can, for example, be used to generate a timely warning for other road users.

As mentioned above, as an alternative, a water level gradient may also be used for the comparisons. For this purpose, two sensor variables of the first sensor are detected within a time interval in order to derive a dynamic change in the water level in contact and thus the rise in the water level. This water level gradient can then also be used for the first and second comparison. In this case, it can be detected in the second comparison with appropriate threshold values whether the rise in the water is increasing, remaining the same, or decreasing.

According to an example embodiment of the present invention, the threshold values used for the comparisons can be varied depending on the driving state of the vehicle. For example, lower threshold values can be set for a stationary or parked vehicle than for a moving vehicle. Optionally, it would also be possible to select the threshold values on the basis of the vehicle speed or vehicle acceleration. Alternatively, it would be possible to define the threshold values for speed ranges or acceleration ranges, e.g., for speeds of 0 km/h, 0 km/h<v<5 km/h, 5 km/h<v<20 km/h and 20 km/h<v.

According to an example embodiment of the present invention, on the basis of the recognition of the rise in water on the vehicle, in particular over a longer period of time, for example the predetermined time duration, at least one component in the vehicle can be controlled in order to avert damage to the vehicle or the occupants. For example, with a recognized rise in water or corresponding water level information, the vehicle's battery can be switched to a currentless state or protected against water ingress. Such a procedure is in particular important for electrically driven vehicles. Optionally, instead of completely deactivating or interrupting the power supply, emergency operation can be ensured at least for a certain time period, especially in electrically driven vehicles, in order to be able to make an emergency call, to assist the occupants when leaving the vehicle, or to maneuver the vehicle out of the danger zone. The latter can also take place automatically in vehicles that can be operated (partially) autonomously. Further components that can be controlled or operated on the basis of the recognized rise in water or the water level information would, for example, be a door opening, a window lifter, a hazard warning system, a brake, a steering system or, in the case of a convertible, a convertible top actuator. Furthermore, protective measures against the ingress of water can be activated, e.g., reversible or irreversible seals or shielding of electrical lines.

According to an example embodiment of the present invention, different sensor variables of different sensor types can be used individually or in combination both to detect the rise in water and to generate the water level information. It is possible, for example, to use a pressure sensor and a hose connected to it to detect the air pressure generated by the rising water in the hose. In addition, pressure sensors, other force sensors, ultrasonic sensors, lidar systems, and/or cameras on the body can recognize rising water in that the water directly acts on the body or in that the evaluation of the characteristic reflections of the detection variables on a water surface indicate a rise in the water level. Furthermore, the driving state of the vehicle can be recognized by means of movement variables, such as acceleration variables or rotation rates. The geoposition or the location of the vehicle and/or the rise in water on the vehicle can also be detected and used for the comparisons or the recognition of the rise in water and to generate the water level information.

For example, according to an example embodiment of the present invention, it is possible to distinguish whether the vehicle is moving, standing still, or substantially at a standstill during the recognized rise in water. The movement of the vehicle due to the recognized rise in water can also be detected, in particular in order to obtain therefrom findings and information regarding the extent of the rise in water and the associated amount of water. For example, it can be recognized whether a previously parked vehicle is drifting away. Furthermore, an inclination sensor can, for example, be used to detect whether the vehicle was located or was moving on a substantially level road or was moving on a slope, for example in the direction of a body of water, when the rise in water was recognized. The latter can, for example, be detected in conjunction with the geoposition of the vehicle and map data or environmental data.

In a further embodiment of the present invention, the water level information can be transmitted to external recipients by means of a transmission module in the vehicle, optionally also as an extension to eCall. It is thus possible to send this water level information or a series of data and information on the detected water level and/or its rise dynamics to a processing unit, for example a central server. Further recipients of the data transmitted with the water level information could be other road users (for example via mobile radio units), a traffic control center, infrastructure operators such as charging column operators, but also garages or insurance companies. The geoposition and/or the dynamics of the recognized rise in water can also be transmitted with the information about the rise in water. It is thus possible that this information could be used to deactivate charging stations in the vicinity in order to protect potential users of these charging stations but also to avoid consequential damage. For emergency services, the water level information can be supplemented with data on the number and location of people in the vehicle as well as the opening state of the windows and/or doors. Optionally, landmarks of the surrounding area can also be transmitted by means of camera images in order to identify the location of the vehicle.

According to an example embodiment of the present invention, it is furthermore provided to operate a processing unit with the water level information collected in this way, for example a processing unit in the form of a central server, which processes the findings from this information and forwards them to other recipients. From the information transmitted in this way, the processing unit can recognize a dangerous situation for the occupants of the vehicle, but also for other road users or the surrounding infrastructure, and can initiate appropriate measures. It is thus possible to use the recognized rise in water, in particular when confirmed by further feedback from vehicles or other (weather) information, to deduce a (local) flood wave. Another possibility when evaluating the water level information is to be able to estimate the damage to the vehicle as early as possible in order to contact a suitable garage for repairs. It is also possible that information is sent to a fleet operator who can use the available information to inform the other vehicles in the fleet and move them out of the danger zone.

The present invention makes it possible to recognize rising water on the body of a vehicle, especially when the vehicle is substantially stationary or moving at a very low speed. While the rise occurs suddenly when a vehicle falls into a body of water, the slower dynamics of the rise in water can also be recognized on the flat. In addition, the present invention is of course also applicable if the vehicle falls into a body of water.

A further special feature of the present invention is that, by detecting the location on the vehicle where the water is rising, appropriate targeted measures can be initiated in local relation to the installation locations of the water-critical components of the vehicle.

Further advantages can be seen from the following description of exemplary embodiments of the present invention and the rest of the disclosure herein.

### BRIEF DESCRIPTION OF THE DRAWINGS

FIG. 1 schematically shows an example evaluation unit which performs a method according to the present invention.

FIG. 2 shows a flow chart of a method according to an example embodiment of the present invention.

FIG. 3 shows a processing unit that draws conclusions about possible hazard potentials on the basis of the transmitted water level information and forwards them to third parties, according to an example embodiment of the present invention.

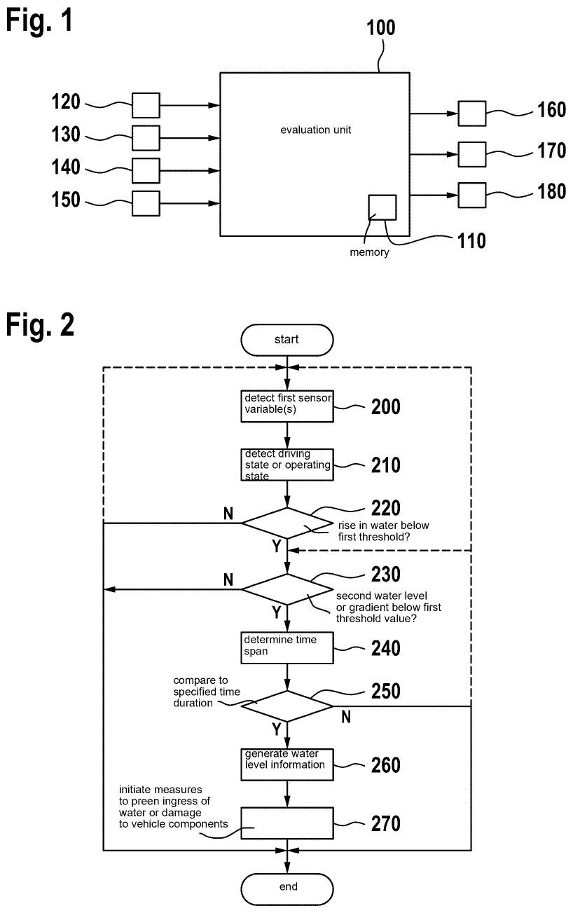

### DETAILED DESCRIPTION OF EXAMPLE EMBODIMENTS

As described above, the present invention provides a method and a device by means of which a rising water level in the environment of the vehicle and in particular on at least part of the vehicle body can be determined. For this purpose, an evaluation unit 100, which can be implemented, for example, in the form of an airbag control unit or brake control unit, first records sensor variables of a first sensor 120. These sensor variables are selected such that they can detect a water level that is in contact with the vehicle and, in particular, rising.

In the present exemplary embodiment, pressure sensor variables are recorded, which detect a rising air pressure in a hose which increasingly fills with water as the water level rises. Such a pressure sensor may, for example, be installed on the underbody in the region of the fenders, on the wheel well, in the engine compartment, on the bumpers, or in the region of the doors. Further sensors that can recognize a rise in water on or around the vehicle include force sensors on the body, humidity sensors, ultrasonic sensors, lidar sensors, cameras, or acceleration sensors. It is also possible to use sensors already used in the vehicle for other functions, in particular pressure sensors, for recognizing the rise in water.

On the basis of the sensor variables thus detected by means of the first sensor 120, it can be recognized, by comparing them to threshold values stored in a memory 110, whether and with what dynamics the water on the body is rising. It can furthermore be recognized whether the rise could be hazardous to the operation of the vehicle and/or the safety of the vehicle occupants. If such a hazard is recognized, the component 160 at risk can be controlled to avoid or reduce damage to the vehicle and/or the occupants. It would be possible, for example, that a battery is switched to a currentless state if a potential rise in water up to the contacts or other electrical lines could occur. In addition, the doors or windows can also be controlled in order to make it possible for the vehicle's occupants to escape. Furthermore, water level information can be derived from the recognized rise in water and made available to third parties. This water level information or a data set on the water level information can thus be transmitted to an external processing unit, for example a central server. This central server can then process and/or use the collected information for further purposes, for example to estimate a hazard potential for other road users or the surrounding infrastructure. In addition, the water level information collected in this way as well as the further data on the recognized situation can be forwarded to fleet operators, garages, traffic control centers, insurance companies, infrastructure operators such as charging column operators, weather services, or other road users. If a rise in water has been recognized in the front region of the vehicle, it would, for example, be possible to use car-to-car information to inform following vehicles of the dangerous situation. It would also be possible to directly alert nearby charging stations to the rise in water so that they can be switched to a safety mode or deactivated.

In addition to recognizing the rise in water on the body, a driving state of the vehicle is detected by means of a second sensor 130. Typical sensor variables that provide information about the driving state or operation of the vehicle include speeds, acceleration variables, rotation rates and also the inclination angles of the road. The driving state detected in this way can be used both to derive the rise in water and to generate the water level information. For example, resistance due to water masses in the direction of travel can be deduced from a change in speed or acceleration in the direction of travel, with otherwise constant drive energy. The driving state and in particular the state of motion in the form of the speed and/or the acceleration can also be used to derive or change the threshold values. Optionally, the evaluation unit 100 can also detect the geoposition of the vehicle, for example by means of a GPS.

As already mentioned, the rise in the water level on the vehicle can be recognized in different ways. In addition to the sensor variables of the first sensor 120, at least one further sensor 150 can be used, with which the rise in the water can be checked redundantly. For example, camera images, ultrasonic sensor variables, or LIDAR sensor signals can be used and evaluated.

The flow chart in FIG. 2 is used to describe a possible design for detecting the rise in water and in particular the dynamics thereof. In a first step 200, at least one first sensor variable of a first sensor is detected, the sensor value of which directly or indirectly represents a change in the water level in contact with the vehicle. A water level value could also be derived directly from this sensor variable. Alternatively, two sensor variables of the first sensor can also be detected in order to derive a water level gradient from their changes. In a further step 210, the driving state or operating state of the vehicle is detected by means of suitable sensor variables of a second sensor. Optionally, the operating status of various components where a rise in water could have critical effects can additionally be detected. Common sensor variables from which the driving state can be derived include the speed, an acceleration or a rotation rate. Optionally, further sensor variables can also be detected, which can be used to double-check the rise in water, for example ultrasonic variables, lidar signals, and camera images, from which the presence of water around the car can also be detected and used to verify the recognition of the rise in water. Furthermore, a location variable can be detected in order to detect the geoposition of the vehicle.

The first sensor variable detected in step 200, a first water level value derived therefrom, or a first water level gradient is compared to a first threshold value in the first comparison 220 in order to recognize whether the rise in the water has reached a region that is of concern for the vehicle and/or for certain components. If the rise in water is still below the first threshold, the method can be terminated or repeated starting with step 200. On the other hand, if it is recognized that the water level has reached or exceeded this first threshold value, a second comparison is carried out in step 230. For this second comparison, at least one first sensor variable of the first sensor, a second water level value derived therefrom, or a second water level gradient is again compared to the first threshold value. The further first sensor variable can be detected in step 200 or only in step 230, wherein it is essential that sufficient time has elapsed between the detection of the first sensor variables of the first sensor in order to be able to detect a change in the rise. If it is determined in the second comparison of step 230 that the later first sensor variable or the second water level value derived therefrom is below the first threshold value, it can be assumed that the water level is falling. In this case, the method is terminated or repeated starting with step 200. However, if an exceedance is determined in step 230, the time span between the first sensor variables used for the comparisons is determined in the following step 240. This time span is compared in step 250 to a specified time duration in order to check the effect of the water on the vehicle and in particular on the components thereof. If the time span is less than the predetermined time duration, it can be assumed that there are no significant impairments. In this case, the method can be terminated or repeated starting with step 200 or the detection of further first sensor variables and the second comparison. If it is determined that the rise in water lasts for at least the predetermined time duration, water level information is generated in step 260, possibly with further relevant information that could be useful to third parties. Optionally, this step may also include transmitting the water level information and all further relevant data to third parties, for example wirelessly to a processing unit or a central server.

In the method described above, it may also be provided that the further first sensor variable is only carried out after the predetermined time duration has elapsed. In this case, it is recognized to what extent there is a change in the rise in water after the predetermined (minimum) time duration. In general, the time duration may also be varied in both procedures or the first sensor variable of the first sensor can be detected again in step 230 before the second comparison in order to detect the further course of the rise in water, for example in order to detect different hazard potentials for different components.

Optionally, it may be provided that, in a further step 270, measures are initiated to prevent ingress of water or damage to the vehicle components. If a problematic rise in water is recognized, it is thus possible to deactivate the battery or to open the doors and/or windows so that the occupants can escape from the passenger compartment in an emergency.

In a further embodiment of the invention, the second comparison in step 230 takes place in two parts. Thus, a comparison can be carried out first with the same first threshold value as in the first comparison 220. If the first sensor variable or the water level value continues to be above this first threshold, a further comparison takes place with a higher threshold value. The result of this further comparison can be taken into account when generating the water level information, in particular in order to communicate the dynamics of the rise in water.

Instead of the water level value in steps 200 and 230, a gradient of the water level values can also be used for the comparisons in steps 220 and 230. In this case, the threshold values must be selected such that even a constant rise can be assumed to pose a risk to the vehicle, its components, or the occupants. Optionally, the decision in the second comparison 230 is thus only fulfilled if the water level gradient is not negative.

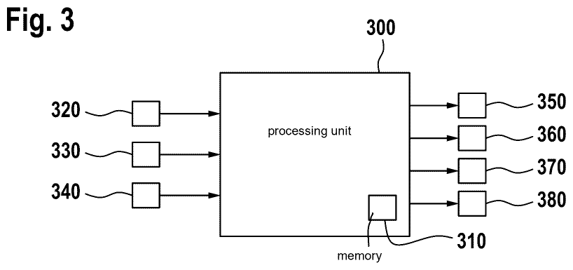

The information thus recognized about a rise in water can be transmitted to third parties, as already mentioned above. FIG. 3 shows, by way of example, a processing unit 300 which records, evaluates and further processes the water level information as well as all further, optionally detected, derived, or determined data of at least one vehicle 320. Based on the information and data thus obtained, the processing unit, for example in the form of a central server, can derive a hazard potential of the rise in water for other road users 350 or for a charging infrastructure in the form of charging stations 360. On the basis of the derived hazard potential, the road users 350 or the operators of the charging infrastructure can be informed. Other possible recipients for the hazard potential may be a traffic control center, emergency services, or disaster control 380. It is also possible to forward the information and/or the hazard potential to a weather service. Optionally, it may also be provided that the charging stations near the rise in water are deactivated directly. It is also possible that, on the basis of the damage detection or the damage analysis carried out on the vehicle in the processing unit 300, a garage 370 or an insurance company is informed directly. If the vehicle is part of a fleet, the fleet operator can also be informed, for example in order to bring other vehicles in their fleet to safety, to support the affected vehicle, or to be able to estimate the damage in advance. For deriving the hazard potential or the damage analysis, the processing unit 300 may have a memory 310 with corresponding information.

The processing unit 300 may optionally also wait for data from a plurality of vehicles 330 and/or obtain the other information for deriving the hazard potential, for example from a weather service 340.

1-15. (canceled)

16. A method for recognizing a rise in a water level which is in contact at least with part of a vehicle, the method comprising the following steps:
determining at least two sensor variables of a first sensor which can change directly or indirectly due to a rising water level on the vehicle;
detecting a driving state of the vehicle;
carrying out a first comparison based on at least one first sensor variable of the first sensor or a water level value derived from the at least one first sensor variable;
carrying out a second comparison based on at least one second sensor variable of the first sensor or a water level value derived from the at least one second sensor variable;
determining a time span based on the first comparison and the second comparison;
comparing the time span to a predetermined time duration in a third comparison; and
generating water level information based on the third comparison and the driving state.

17. The method according to claim 16, wherein, in the first and/or second comparison, an exceedance of a threshold value is determined using the at least one first sensor variable of the first sensor, or a water level value derived from the at least one first sensor variable, or a water level gradient between two derived water level values, wherein a lower first threshold value is used for the first comparison and a higher second threshold value is used for the second comparison.

18. The method according to claim 16, wherein, in the second comparison:
an exceedance of a first threshold value is determined using the at least one second sensor variable of the first sensor, or a water level value, or the water level gradient between two determined water level values,
based on the exceedance of the first threshold value being determined, an exceedance of a higher second threshold value is determined using the at least one second sensor variable of the first sensor, or a water level value, or the water level gradient between two determined water level values;
wherein the water level information is additionally generated based on the determination of the exceedance of the second threshold value.

19. The method according to claim 17, wherein at least one threshold value is defined based on the vehicle state, wherein the threshold value is defined based on a speed of the vehicle or an acceleration of the vehicle.

20. The method according to claim 16, further comprising:
controlling a component of the vehicle based on the water level information, including deactivating energy connections of a battery of the vehicle or activating protection of the battery against water in contact with contacts of the battery.

21. The method according to claim 16, further comprising:
detecting at least a location variable, and/or a movement variable, and/or a pressure variable, and/or a camera image; and
taking into account the location variable, and/or the movement variable, and/or the pressure variable, and/or the camera image, when carrying out the first comparison and/or when carrying out the second comparison and/or when generating the water level information.

22. The method according to claim 16, further comprising:
transmits at least the water level information: to a central server, and/or to other road users, and/or to a fleet operator, and/or to a garage, and/or to a charging column operator, and/or to an insurance company, wherein a current geoposition of the vehicle, and/or movement data of the vehicle, and/or a number and a location of the people in the vehicle, and/or an opening state of windows and/or an opening state of doors, and/or landmarks of a surrounding area, are also transmitted.

23. A device for recognizing a rise in a water level which is in contact at least with part of a vehicle, comprising:
an evaluation unit which is part of an airbag control apparatus of the vehicle, wherein the evaluation unit is configured to:
determine at least two water level values, in each case using at least one sensor variable of a first sensor;
detect a driving state of the vehicle using a second sensor,
carry out a first comparison based on at least one first water level value,
carry out a second comparison based on at least one second water level value,
determine a time span based on the first comparison and the second comparison,
compare the time span to a predetermined time duration in a third comparison, and
generate water level information based on the third comparison and the driving state.

24. The device according to claim 23, wherein the evaluation unit is configured to determine, in the first comparison and/or the second comparison, an exceedance of a threshold value using at least one water level value or a water level gradient between two determined water level values, wherein a lower threshold value is used for the first comparison than for the second comparison.

25. The device according to claim 23, wherein the evaluation unit is configured to control a component of the vehicle based on the water level information, including deactivating energy connections of a battery of the vehicle or activating protection of the battery against water in contact with contacts of the battery.

26. The device according to claim 23, wherein the evaluation unit is configured to, using a wireless transmission unit, transmit: at least the water level information to a processing unit and/or a central server and/or other road users and/or a fleet operator and/or a garage and/or a charging station and/or an insurance company, wherein evaluation unit is additionally configured to transmit: ae current geoposition of the vehicle and/or movement data of the vehicle, and/or a number and location of people in the vehicle and/or an opening state of windows and/or an opening state of doors and/or landmarks of a surrounding area.

27. A processing unit incluiding a central server, which receives transmitted water level information generated by a vehicle, the water level information being generated by:
determining at least two sensor variables of a first sensor which can change directly or indirectly due to a rising water level on the vehicle,
detecting a driving state of the vehicle,
carrying out a first comparison based on at least one first sensor variable of the first sensor or a water level value derived from the at least one first sensor variable,
carrying out a second comparison based on at least one second sensor variable of the first sensor or a water level value derived from the at least one second sensor variable,
determining a time span based on the first comparison and the second comparison,
comparing the time span to a predetermined time duration in a third comparison, and
generating the water level information based on the third comparison and the driving state;
wherein the processing unit is configured to, based on the received water level information, determine hazard information which is transmitted to disaster control and/or a rescue service and/or a traffic control center and/or a garage and/or other road users and/or charging columns and/or charging column operators and/or an insurance company.

28. The processing unit according to claim 27, wherein, based of the water level information and a transmitted geoposition of the vehicle, the processing unit estimates a risk that electrical charging stations in an area of the geoposition should be deactivated for safety reasons with regard to their functionality or danger to users, wherein the processing unit, based on danger information, sends out indirect or direct control signals to deactivate at least one electrical charging station in an area of the geoposition.

29. The processing unit according to claim 27, wherein the processing unit is configured to predict a further rise in the water level or a spread of the rise in water in an area of the geoposition from at least two pieces of water level information transmitted by different vehicles and respective geopositions, wherein the processing unit is configured to transmit the prediction of the further rise in the water level or the spread of the rise in water to disaster control and/or a rescue service and/or a traffic control center and/or other road users.

30. The processing unit according to claim 27, wherein, based on the water level information, the processing unit is configured to estimate damage caused to the vehicle, and wherein the processing unit is configured to transmit information regarding the estimated damage to a garage and/or a fleet operator and/or an insurance company.
